(19) United States
(12) Patent Application Publication
(10) Pub. No.: US 2008/0266274 A1
(43) Pub. Date: Oct. 30, 2008

(54) METHOD OF DRIVING A DISPLAY PANEL

(75) Inventor: Po-Sheng Shih, Taoyuan (TW)

Correspondence Address: J C PATENTS, INC., 4 VENTURE, SUITE 250, IRVINE, CA, 92618, US

(73) Assignee: HANNSTAR DISPLAY CORPORATION, Tao-Yuan Hsien (TW)

(21) Appl. No.: 11/836,390

(22) Filed: Aug. 9, 2007

(30) Foreign Application Priority Data
Apr. 25, 2007 (TW) 96114548

(51) Int. Cl. G06F 3/038

(52) U.S. Cl. 345/204

(57) ABSTRACT

A method for driving a display panel is provided. First, a first gate line is enabled and a first data is provided to a sub-pixel coupled to the first gate line at a first time duration in a frame period. Next, the first gate line is enabled and a second data is provided to the sub-pixel coupled to the first gate line at a second time duration in the frame period. Herein, the first time duration precedes the second time duration. Further, the second data is a display data of the sub-pixel coupled to the first gate line, and the first data is a display data of a sub-pixel coupled to a second gate line.

### CROSS-REFERENCE TO RELATED APPLICATION

This application claims the priority benefit of Taiwan application serial no. 96114548, filed Apr. 25, 2007. All disclosure of the Taiwan application is incorporated herein by reference.

### BACKGROUND OF THE INVENTION

1. Field of the Invention

The present invention relates to a driving method, and more particularly, to a method for driving a display panel.

2. Description of Related Art

Generally, a check sub-pixel pattern method, for example, a check 1-dot pattern method, is utilized to determine the display quality of a liquid crystal display, as shown in FIG. 1 and FIG. 2. To facilitate the illustration, the display panel described below utilizes a normally black display mode.

FIG. 1 and FIG. 2 are views respectively illustrating the check 1-dot pattern shown when displaying the N^{th} frame and the (N+1)^{th} frame. Further, the sub-pixels that are coupled to the K^{th} gate line and the (K+1)^{th} gate line in the display panel are used as examples. Herein, both N and K are natural numbers. In FIG. 1 and FIG. 2, R, G, and B respectively represent the sub-pixels displaying red, green and blue. In addition, + sign represents the voltage of the display data loaded to the sub-pixel is greater than the common potential of the same sub-pixel, while − sign represents the voltage of the display data loaded to the sub-pixel is smaller than the common potential of the same sub-pixel. Additionally, each light color region and each dark color region respectively represent one pixel. The brightness of the light color region is greater than that of the dark color region. In other words, the voltage of the display data loaded to the pixels in the light color region is greater than that in the dark color region.

Nevertheless, utilizing a check sub-pixel pattern method, for example, a check 1-dot pattern method, to determine the display quality of a display frame results in the generation of color shift in the frame displayed if the display panel is driven conventionally by the gate line (i.e. each gate line is sequentially enabled once within the same frame period). To understand why color shift occurs, the hardware structure of each sub-pixel needs to be first explained, followed by explaining the conventional method for operating each pixel.

FIG. 3 is a schematic view illustrating the hardware structure of each TN-mode sub-pixel. In FIG. 3, 301 and 302 represent source lines, 303 and 304 represent gate lines, 305˜307 represent common potential lines of the thin film transistor (TFT) array substrate side, 308 represents a pixel electrode, and 309 represents a thin film transistor. FIG. 4 is a schematic view illustrating an equivalent circuit diagram of the structure shown in FIG. 3. In FIG. 4, 301, 302, 303, 304 and 309 respectively correspond to the same components shown in FIG. 3. On the other hand, AVcom represents the voltage level of the common potential lines 305˜307, while CVcom represents the common potential of an opposite substrate opposite to the TFT array substrate, i.e. the common potential on the color filter substrate side. 401 represents the parasitical capacitance between the source line 301 and the common potential AVcom. 402 represents the parasitical capacitance between the source line 302 and the common potential AVcom. 403 represents the storage capacitance between the pixel electrode 308 and the common potentials 305˜307. 404 represents the liquid crystal capacitance between the pixel electrode 308 and the opposite substrate.

As shown by the equivalent circuit in FIG. 4, when the gate line 304 is enabled to turn on the thin film transistor 309. Further, the signal transmitted by the source line 302 affects the level of the common potential AVcom via the storage capacitance 403. The reasons for causing color shift are illustrated below using FIG. 5 in combination with FIG. 1 and FIG. 6 in combination with FIG. 2. Further, only light color regions in FIG. 1 and FIG. 2 that show more severe color shift are illustrated.

FIG. 5 is a schematic view illustrating the operation waveform diagram of one of the light color regions shown in FIG. 1. Please refer to FIG. 5. Herein, G1 represents the voltage level of the (K+1)^{th} gate line. When the gate line voltage G1 coupled to the sub-pixels in the light color regions is high, the source lines that are coupled to the sub-pixels respectively load the display data V_{R}, V_{G} and V_{B} to the red sub-pixel R, the green sub-pixel G, and the blue sub-pixel B. Simultaneously, since the display data V_{R} and V_{B} independently change from negative to positive, only the display data V_{G} changes from positive to negative. Further, the display data V_{R}_{, V}_{G} and V_{B} respectively affect the level of the common potential AVcom via the storage capacitance 403 in the red sub-pixel R, the green sub-pixel G, and the blue sub-pixel B. More specifically, the level of the common potential AVcom is increased towards the positive polarity, and returns to the original level after the time point T.

According to FIG. 5, when the gate line voltage G1 changes from high to low, the voltage difference between the display data, V_{R} and V_{B}, and the common potential AVcom is smaller than that between the display data V_{G} and the common potential AVcom, making the brightness of the green sub-pixel G comparatively brighter than that of the red sub-pixel R and the blue sub-pixel B. Hence, the image displayed by the light color region is somewhat green.

FIG. 6 is a schematic view illustrating the operation waveform diagram of one of the light color regions shown in FIG. 2. Please refer to FIG. 6. Herein, G1 represents the voltage level of the (K+1)^{th} gate line. When the gate line voltage G1 coupled to the sub-pixels in the light color regions is high, the source lines that are coupled to the sub-pixels respectively load the display data V_{R}_{, V}_{G} and V_{B} to the red sub-pixel R, the green sub-pixel G, and the blue sub-pixel B. Simultaneously, since the display data V_{R} and V_{B} independently change from positive to negative, only V_{G} independently changes from negative to positive. Further, the display data V_{R}_{, V}_{G} and V_{B} respectively affect the level of the common potential AVcom via the storage capacitance 403 in the red sub-pixel R, the green sub-pixel G, and the blue sub-pixel B. More specifically, the level of the common potential AVcom is decreased towards the negative polarity, and returns to the original level after the time point T.

According to FIG. 6, when the gate line voltage G1 changes from high to low, the voltage difference between the display data, V_{R} and V_{B}, and the common potential AVcom is smaller than that between the display data V_{G} and the common potential AVcom, making the image displayed by the light color region somewhat green.

### SUMMARY OF THE INVENTION

The present invention is directed to a method for driving a display panel that reduces color shift of the display panel and improves the quality of the image displayed.

In view of the above, the present invention is directed to a method for driving a display panel. First, at a first time duration in a frame period, a first gate line is enabled and a first data is loaded to a sub-pixel coupled to the first gate line. Next, at a second time duration in the frame period, the first gate line is enabled and a second data is loaded to the sub-pixel coupled to the first gate line. Herein, the first time duration precedes the second time duration. Further, the second data is the display data of the sub-pixel coupled to the first gate line, and the first data is a display data of a sub-pixel coupled to a second gate line.

According to one embodiment of the present invention, the time interval of the first time duration and the time interval of the second time duration are equal to a first duration. Further, the time interval between the first time duration and the second time duration equals to a second duration. Additionally, the second duration is in odd multiple of the first duration.

According to another embodiment of the present invention, the time interval of the first time duration and the time interval of the second time duration are equal to a first duration. Further, the time interval between the first time duration and the second time duration equals to a second duration. Additionally, the second duration equals to the first duration. The steps of the driving method further include enabling the second gate line and providing a third data to the sub-pixel coupled to the second gate line at a third time duration in the frame period. Next, at the first time duration in the frame period, the second gate line is enabled and the first data is provided to the sub-pixel coupled to the second gate line. Herein, the third time duration precedes the first time duration, and the time interval of the third time duration is equal to the first duration. Further, the time interval between the third time duration and the first time duration is equal to the second duration. Additionally, the third data is a display data of a sub-pixel coupled to a third gate line.

According to yet another embodiment of the present invention, the time interval of the first time duration and the time interval of the second time duration are equal to a first duration. Further, the time interval between the first time duration and the second time duration equals to a second duration. Additionally, the second duration triples the first duration. The steps of the driving method further include enabling the second gate line and providing a third data to the sub-pixel coupled to the second gate line at a third time frame in the frame period. Next, at the first time duration in the frame period, the second gate line is enabled and the first data is provided to the sub-pixel coupled to the second gate line. Herein, the third time duration precedes the first time duration, and the time interval of the third time duration is equal to the first duration. Further, the time interval between the third time duration and the first time duration is equal to the second duration. Additionally, the third data is a display data of a sub-pixel coupled to a third gate line.

According to yet another embodiment of the present invention, the time interval of the first time duration and the time interval of the second time duration are equal to a first duration. Further, the time interval between the first time duration and the second time duration equals to zero. The steps of the driving method further include enabling the second gate line and providing a third data to the sub-pixel coupled to the second gate line at a third time frame in the frame period. Next, at the first time frame in the frame period, the second gate line is enabled and the first data is provided to the sub-pixel coupled to the second gate line. Herein, the time interval of the third time duration is equal to the first duration, and the third time duration precedes the first time duration. Further, the third data is a display data of a sub-pixel coupled to a third gate line.

According to yet another embodiment of the present invention, the time interval of the first time duration equals to a first duration, and the time interval of the second time duration equals to a second duration. Further, the time interval between the first time duration and the second time duration equals to zero. The steps of the driving method further include enabling the second gate line and providing a third data to the sub-pixel coupled to the second gate line at a third time duration in the frame period. Next, at the first time frame in the frame period, the second gate line is enabled and the first data is provided to the sub-pixel coupled to the second gate line. Herein, the time interval of the third time duration is equal to the second duration, and the third time duration precedes the first time duration. Further, the third data is a display data of a sub-pixel coupled to a third gate line.

In order to the make the aforementioned and other objects, features and advantages of the present invention comprehensible, several embodiments accompanied with figures are described in detail below.

### BRIEF DESCRIPTION OF THE DRAWINGS

FIG. 1 and FIG. 2 are schematic views respectively illustrating the check 1-dot pattern shown when displaying the N^{th} frame and the (N+1)^{th} frame.

FIG. 3 is a schematic view illustrating the hardware structure of a sub-pixel.

FIG. 4 is a schematic view illustrating an equivalent circuit diagram of the structure shown in FIG. 3.

FIG. 5 is a schematic view illustrating the operation waveform diagram of one of the light color regions shown in FIG. 1.

FIG. 6 is a schematic view illustrating the operation waveform diagram of one of the light color regions shown in FIG. 2.

FIG. 7 is a schematic view illustrating a gate line signal according to an embodiment of the present invention.

FIG. 8 is a schematic view illustrating a sequence of the gate line signal shown in FIG. 7.

FIG. 9 is a schematic view illustrating a gate line signal according to an embodiment of the present invention.

FIG. 10 is a schematic view illustrating a sequence of the gate line signal shown in FIG. 9.

FIG. 11 is a schematic view illustrating a gate line signal according to an embodiment of the present invention.

FIG. 12 is a schematic view illustrating a sequence of the gate line signal shown in FIG. 11.

FIG. 13 is a schematic flowchart illustrating a method for driving a display panel according to one embodiment of the invention.

FIG. 14 and FIG. 15 are schematic views respectively illustrating the check row pattern shown when displaying the N^{th} frame and the (N+1)^{th} frame.

FIG. 16 is a schematic view illustrating the operation waveform diagram of one of the pixels that are coupled to the (K+1)^{th} gate line shown in FIG. 14.

FIG. 17 is a schematic view illustrating the operation waveform diagram of one of the pixels that are coupled to the (K+1)^{th} shown in FIG. 15.

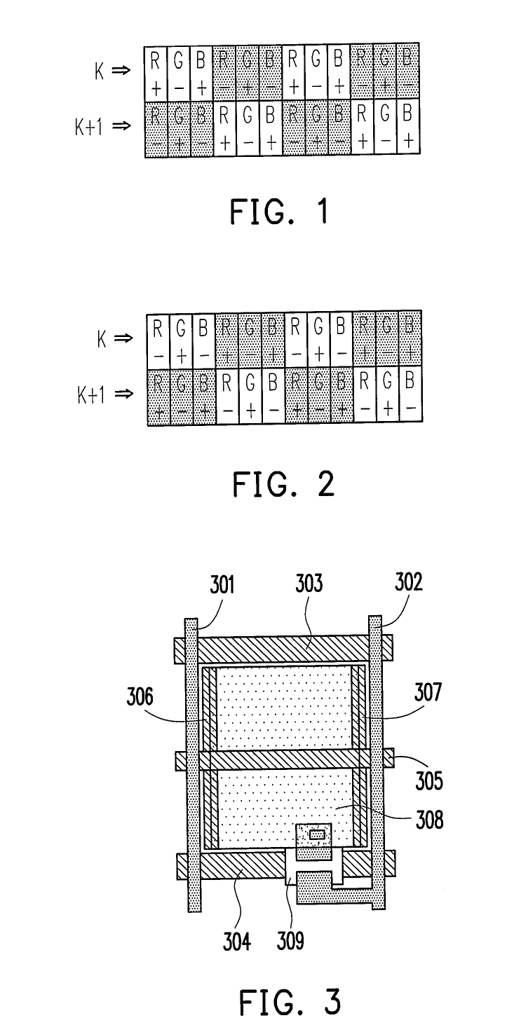

### DESCRIPTION OF EMBODIMENTS

To facilitate the illustration, a normally black display mode is utilized by the display panel described below and a check 1-dot pattern is used as the display image. Nevertheless, the present invention is not limited to be employed in a check 1-dot pattern, it also can be applied to any check sub-pixel pattern.

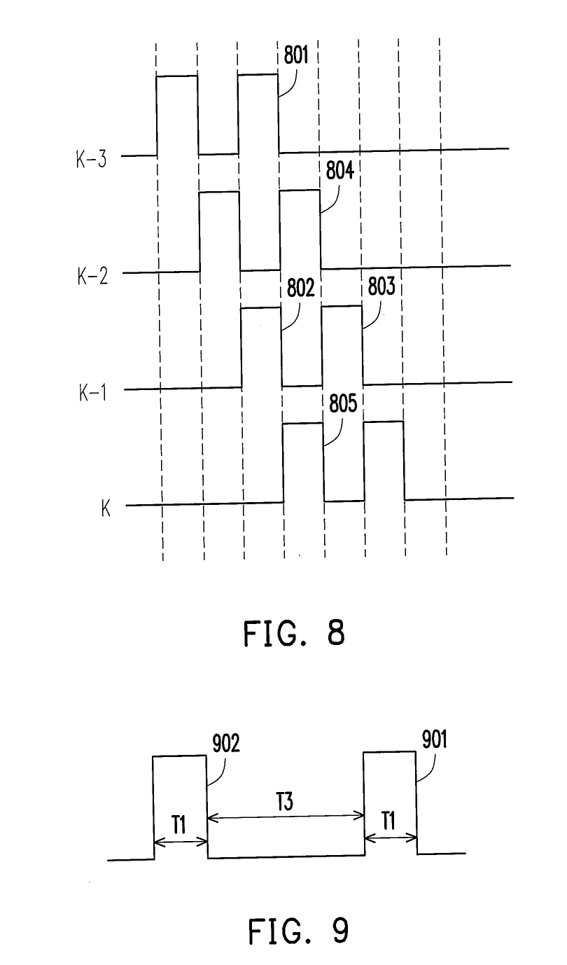

FIG. 7 is a gate line signal according to an embodiment of the present invention. In FIG. 7, 701 represents an original gate line pulse, and 702 represents a compensation pulse, the compensation pulse 702 and the original gate line pulse 701 are respectively at a first time duration and a second time duration in a frame period. Further, the time interval between the compensation pulse 702 and the gate line pulse 701 is T2, and the time intervals of the gate line pulse 701 and the time interval of the compensation pulse 702 are both T1. In addition T2 is equal to T1, but not limited thereto in another embodiment. Please refer to the description of FIG. 8 for an explanation of utilizing the gate line signal described above.

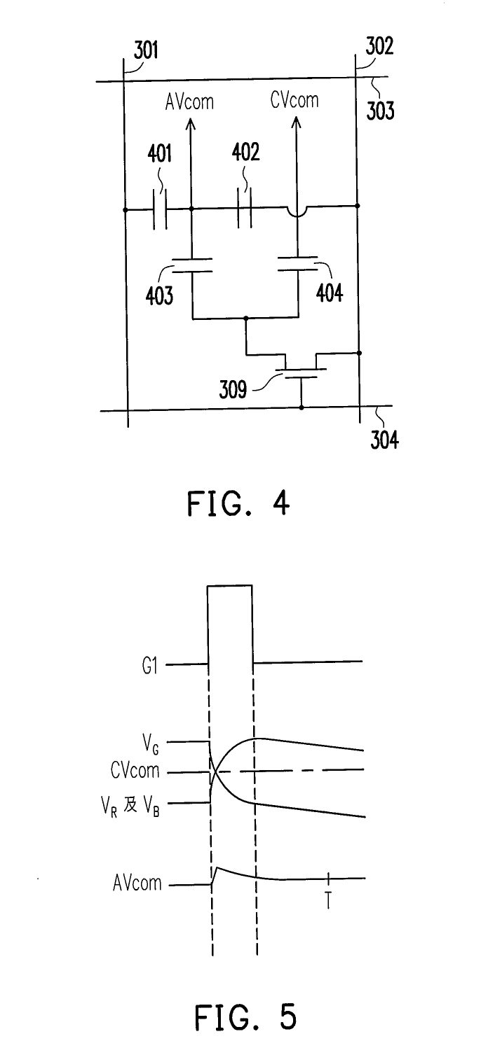

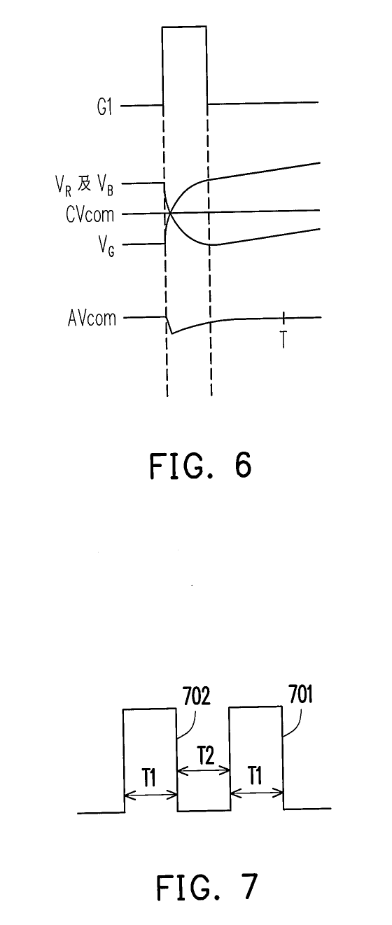

FIG. 8 is a schematic view illustrating a sequence of the gate line signal shown in FIG. 7. Further, gate line signals of four adjacent gate lines K-3˜K are shown as examples. Assume that all the source lines of the display panel follow the driving order of the gate lines K-3˜K and output corresponding display data of the sub-pixels coupled to the gate line that is driven. As shown in FIG. 8, when a gate line pulse 801 of the K-3 gate line shows a high voltage level, the K-3 gate line is enabled. Simultaneously, a compensation pulse 802 of the K-1 gate line shows a high voltage level to enable the K-1 gate line. Since all the source lines correspondingly output the display data of the sub-pixels coupled to K-3 gate line, the sub-pixels coupled the K-1 gate line receive the same display data. In other words, the storage capacitance 403 in each sub-pixel coupled to the K-1 gate line (as shown in FIG. 4) is stored to the display data of the corresponding sub-pixel coupled to the K-3 gate line.

As a result, when a gate line pulse 803 of the K-1 gate line shows a high voltage level and the source lines correspondingly output the display data of the sub-pixels coupled to the K-1 gate line, the sub-pixels coupled to the K-1 gate line store the aforementioned display data. Therefore, only a small change in the voltage can achieve the desired voltage value for displaying images. Accordingly, the display data loaded hardly affect the voltage level of AVcom via the storage capacitance 403 in the sub-pixels. Consequently, the voltage difference between the display data of each sub-pixel and the common potential AVcom is tend to be the same. Hence, color shift is not generated when enabling the K-1 gate line. Conceivably, a gate line pulse 804 of the K-2 gate line and a compensation pulse 805 of the K gate line can be simultaneously enabled. As a result, color shift is not generated when enabling the K gate line. If all gate lines are implemented according to FIG. 8, the occurrence of color shift in a display panel can be greatly reduced. It is noted that although in the embodiment the pulse 803 and 802 are designed to be equal, but in another embodiment, they can be designed to be different.

Similarly, according to FIG. 8, the time interval between the compensation pulse and the gate line pulse can be designed to be in odd multiples of T1 (e.g. as shown in FIG. 9), which likewise reduces the occurrence of color shift in display panels.

FIG. 9 is a gate line signal according to another embodiment of the present invention. In FIG. 9, 901 represents an original gate line pulse, and 902 represents a compensation pulse. Further, the time interval between the compensation pulse 902 and the gate line pulse 901 is T3, and the duration of the gate line pulse 901 and the duration of the compensation pulse 902 are T1. In addition, T3 approximately triples T1, but not limited thereto.

FIG. 10 is a schematic view illustrating a sequence of the gate line signal shown in FIG. 9. Further, gate line signals of five adjacent gate lines K-4˜K are shown as examples. The method shown in FIG. 10 is very similar to that shown in FIG. 8. Hence, any user should be able to infer from the above-teachings and a detailed description thereof is omitted.

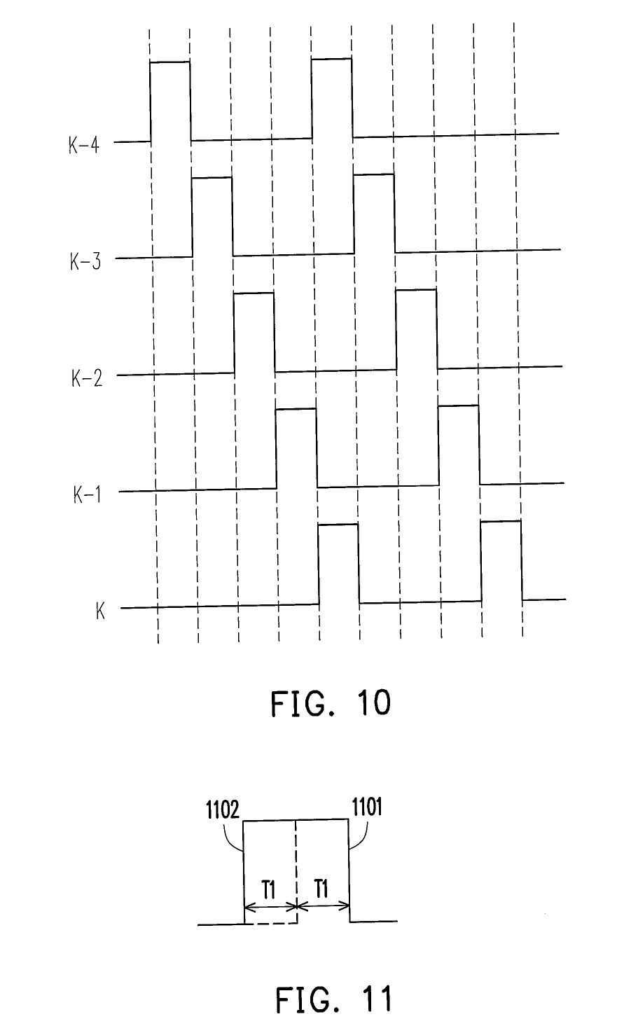

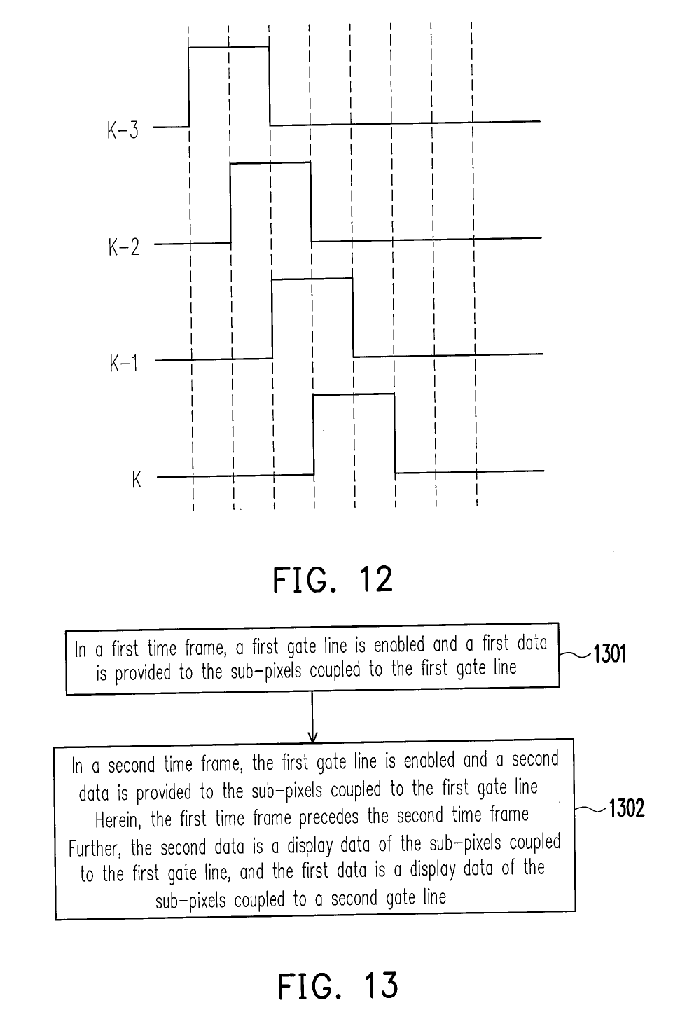

Based on the design principle underlying FIG. 8 and FIG. 10, another implementation that can also prevent the occurrence of color shift in display panels is proposed, which is shown in FIG. 11. FIG. 11 is a gate line signal according to yet another embodiment of the present invention. In FIG. 11, 1101 represents an original gate line pulse, and 1102 represents a compensation pulse. Further, the duration of the gate line pulse 1101 and the duration of the compensation pulse 1102 are T1, and the time interval between the compensation pulse 1102 and the gate line pulse 1101 is 0. In other words, the pulse width of the original gate line pulse is increased. FIG. 12 is a schematic view illustrating a sequence of the gate line signal shown in FIG. 11. Further, gate line signals of four adjacent gate lines K-3˜K are shown as examples.

Certainly, the gate line signal shown in FIG. 11 has a pulse width that is double the pulse width of the original gate line pulse 1101. Further, according to the method shown in FIG. 12, any user should be able to infer from the above-teachings that any gate line signal can be implemented as long as the pulse width of the original gate line pulse 1101 increases in multiples.

Based on the teachings of the above-mentioned embodiments, a general principle can be concluded as shown in FIG. 13. FIG. 13 is a schematic flowchart illustrating a method for driving a display panel according to one embodiment of the invention. Please refer to FIG. 13. First, at a first time duration in a frame period, a first gate line is enabled and a first data is provided to a sub-pixel coupled to the first gate line (as shown in step 1301). Next, the first gate line is enabled and a second data is provided to the sub-pixel coupled to the first gate line at a second time duration in the frame period. Herein, the first time duration precedes the second time duration. Further, the second data is the display data of the corresponding sub-pixel coupled to the first gate line, and the first data is the display data of a sub-pixel coupled to a second gate line (as shown in step 1302).

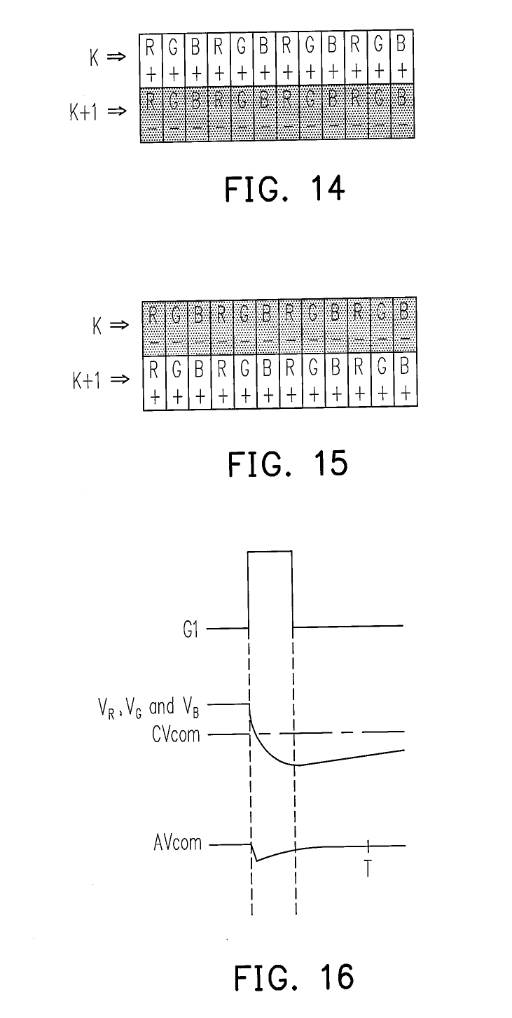

Although the above-mentioned embodiments have taught some embodiments, those skilled in the art should know that the present invention can also be applied in a display panel that utilizes a normally white display mode. Further, the present invention is not limited to displaying a check 1-dot pattern, rather, it can also be used for displaying a normal frame or another kind of check sub-pixel pattern. For an example, the present invention can also be used for displaying a check row pattern. FIG. 14 and FIG. 15 are schematic views respectively illustrating the check row pattern shown when displaying the N^{th} frame and the (N+1)^{th} frame. Further, the sub-pixels that are coupled to the K^{th} gate line and the (K+1)^{th} gate line in the display panel are used as examples. Herein, both N and K are natural numbers.

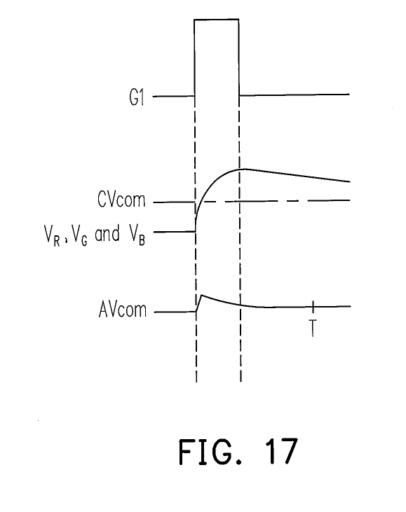

FIG. 16 is a schematic view illustrating the operation waveform diagram of one of the pixels that are coupled to the (K+1)^{th} gate line shown in FIG. 14 when the pixel polarity changes from positive to negative. According to FIG. 16, after the gate line voltage G1 changes from high to low, the voltage difference between the display data, V_{R}_{, V}_{G} and V_{B}, and the common potential CVcom is not always the same. Hence, the image brightness displayed by the pixel is not always the same. FIG. 17 is a schematic view illustrating the operation waveform diagram of one of the pixels that are coupled to the (K+1)^{th} shown in FIG. 15 when the pixel polarity changes from positive to negative. According to FIG. 17, after the gate line voltage G1 changes from high to low, the voltage difference between the display data, V_{R}_{, V}_{G} and V_{B}, and the common potential CVcom is not always the same. Therefore, the image brightness displayed by the pixel is also not always the same. Similarly, based on the essence of the present invention, the above-mentioned problem caused by the check row pattern playing can also be solved by using the aforesaid methods of the present invention.

In view of the above, the present invention includes a compensation pulse that precedes the original gate line pulse or increasing the pulse width of the original gate line pulse to simultaneously enable two gate lines and the sub-pixels coupled to one of the enabled gate lines receive the display data of the corresponding sub-pixels coupled to the other gate line. Therefore, the storage capacitance 403 in each sub-pixel coupled to the gate line that is enabled by the compensation pulse first stores some voltage. When the gate line is enabled again by the gate line pulse, all the source lines output the display data required by the sub-pixels coupled to the same gate line. Hence, only a very small change in voltage is required for each sub-pixel coupled to the gate line to achieve the desired voltage level. Consequently, the occurrence of color shift can be avoided when driving the gate line.

Although the present invention has been disclosed above by the embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A method of driving a display panel for displaying a check sub-pixel pattern, comprising:
enabling a first gate line and providing a first data to a first sub-pixel coupled to the first gate line at a first time duration in a frame period; and
enabling the first gate line and providing a second data to the first sub-pixel at a second time duration in the frame period,
wherein the first time duration precedes the second time duration and the second data is a display data of the first sub-pixel.

2. The method of claim 1, wherein the first data is a display data of a second sub-pixel coupled to a second gate line.

3. The method of claim 1, wherein the time interval of the first time duration is equal to the time interval of the second time duration.

4. The method of claim 3, wherein the time interval between the first time duration and the second time duration is in odd multiples of the time interval of the first time duration.

5. The method of claim 2, further comprising:
enabling the second gate line and providing a third data to the second sub-pixel coupled to the second gate line at a third time duration in the frame period; and
enabling the second gate line and providing the first data to the second sub-pixel at the first time duration in the frame period,
wherein the third time duration precedes the first time duration.

6. The method of claim 5, wherein the time interval of the first time duration is equal to the time interval of the third time duration.

7. The method of claim 6, wherein the time interval between the first time duration and the third time duration is in odd multiples of the time interval of the first time duration.

8. The method of claim 5, wherein the time interval of the first time duration, the time interval of the second time duration and the time interval of the third time duration are equal.

9. The method of claim 5, further comprising:
enabling a third gate line and providing a fourth data to a third sub-pixel coupled to the third gate line at a fourth time duration in the frame period; and
enabling the third gate line and providing a fifth data to the third sub-pixel at a fifth time duration in the frame period,
wherein the fifth data is a display data of the third sub-pixel, and the first time duration, the second time duration, the fourth time duration and the fifth time duration do not overlap.

10. The method of claim 9, wherein the fourth time duration is between the third time duration and the first time duration, and the fifth time duration is between the first time duration and the second time duration.

11. The method of claim 9, wherein the time interval of the fourth time duration is equal to the time interval of the fifth time duration.

12. The method of claim 9, wherein the time interval of the first time duration, the time interval of the second time duration, the time interval of the fourth time duration, and the time interval of the fifth time duration are equal.

13. The method of claim 12, wherein the time interval between the first time duration and the second time duration is in odd multiples of the time interval of the fourth time duration.

14. The method of claim 1, wherein the time interval between the first time duration and the second time duration is zero.

15. The method of claim 5, wherein the time interval between the first time duration and the second time duration is zero, and the time interval between the first time duration and the third time duration is also zero.

16. The method of claim 15, wherein the time interval of the first time duration, the time interval of the second time duration, and the time interval of the third time duration are equal.

17. The method of claim 1, wherein the first gate line is coupled to a plurality of pixels and each pixel comprises a plurality of sub-pixels, wherein each sub-pixel respectively displays red or green or blue.

18. The method of claim 17, wherein the polarities of two adjacent sub-pixels are opposite.
